(19) United States
(12) Patent Application Publication
(10) Pub. No.: US 2013/0281123 A1
(43) Pub. Date: Oct. 24, 2013

(54) INFORMATION-PROCESSING DEVICE, METHOD, INFORMATION-PROCESSING SYSTEM, AND COMPUTER-READABLE NON-TRANSITORY STORAGE MEDIUM

(71) Applicant: Masato KUWAHARA, Minami-ku (JP)

(72) Inventor: Masato KUWAHARA, Minami-ku (JP)

(73) Assignee: NINTENDO CO., LTD, Kyoto (JP)

(21) Appl. No.: 13/549,924

(22) Filed: Jul. 16, 2012

(30) Foreign Application Priority Data
Apr. 18, 2012 (JP) 2012-094555

(51) Int. Cl. H04W 4/02

(52) U.S. Cl. 455/456.3

(57) ABSTRACT

An exemplary information-processing device includes: an identifying unit configured to identify an event occurring at a location of the information-processing device; a communication unit configured to communicate with another information-processing device which is within an area including the location of the information-processing device and a location where the event occurs; and a processing unit configured to execute a process relating to the event identified by the identifying unit, together with the other information-processing device communicating via the communication unit.

### CROSS REFERENCE TO RELATED APPLICATIONS

This application is based on and claims priority under 35 USC 119 from Japanese patent application No. 2012-94555, which was filed on Apr. 18, 2012.

### FIELD

The technology disclosed herein relates to an information-processing device, a method, an information-processing system, and a computer-readable non-transitory storage medium for storing location information.

### BACKGROUND AND SUMMARY

A game played on a portable terminal using location information obtained by the portable terminal is known.

An exemplary embodiment provides a common process by plural portable terminals, relating to an event identified in response to a location of a portable terminal.

According to this exemplary embodiment, there is provided an information-processing device including: a first identifying unit configured to identify an event occurring at a location of the information-processing device; a communication unit configured to communicate with another information-processing device which is within an area including the location of the information-processing device or a location where the event occurs; and a processing unit configured to execute a process relating to the event identified by the first identifying unit, together with the another information-processing device communicating via the communication unit.

### BRIEF DESCRIPTION OF THE DRAWINGS

Exemplary embodiments will now be described with reference to the following drawings, wherein:

FIG. 1 shows an exemplary non-limiting configuration of information-processing system 1;

FIG. 2 shows an exemplary non-limiting functional configuration of portable terminal 10;

FIG. 3 shows an exemplary non-limiting hardware configuration of portable terminal 10;

FIG. 4 shows an exemplary non-limiting database 212;

FIG. 5 shows an exemplary non-limiting flow chart illustrating an operation of portable terminal 10;

FIG. 6 shows an exemplary non-limiting display of a combined image;

FIG. 7 shows exemplary non-limiting locations of portable terminals 10;

FIG. 8 shows an exemplary non-limiting select menu;

FIG. 9 shows an exemplary non-limiting confirmation menu; and

FIG. 10 shows an exemplary non-limiting display of a message.

### DETAILED DESCRIPTION OF NON-LIMITING EXEMPLARY EMBODIMENT

### 1. Configuration

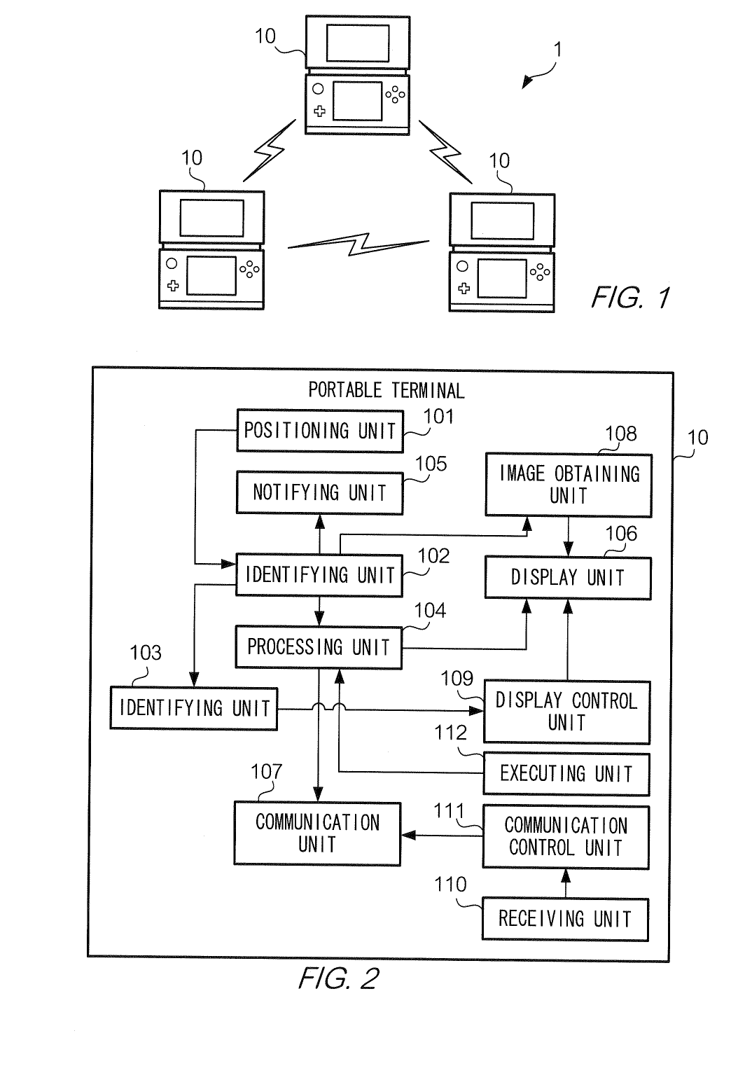

FIG. 1 shows an exemplary configuration of information-processing system 1 in accordance with one exemplary embodiment. Information-processing system 1 includes plural portable terminals 10. Each of plural portable terminals 10 executes an application program that uses location information of the portable terminal 10. According to the application program, an event corresponding to the location information is identified, and a process corresponding to the identified event is executed. Further, if two or more portable terminals 10 are within a communication range of a near field communication, a common process relating to the identified event is executed by the two or more portable terminals 10. In the following description, a suffix such as portable terminal 10A, or portable terminal 10B, are used to identify each of plural portable terminals 10.

FIG. 2 shows an exemplary functional configuration of portable terminal 10. Portable terminal 10 includes positioning unit 101, identifying unit 102, identifying unit 103, processing unit 104, notifying unit 105, display unit 106, communication unit 107, image obtaining unit 108, display control unit 109, receiving unit 110, communication control unit 111, and executing unit 112.

Positioning unit 101 obtains location information indicating its own location, so as to use the location information to determine whether portable terminal 10 is at a location where an event occurs. Identifying unit 102 identifies an event corresponding to the location information obtained by positioning unit 101. Identifying unit 103 identifies another portable terminal 10, which is within an area including the location of one of portable terminals 10 (portable terminal 10A, for example), so as to establish a communication connection with the other portable terminal 10 (portable terminal 10B, for example). Processing unit 104 executes a process relating to the event identified by identifying unit 102, together with the other portable terminal 10 (portable terminal 10B) identified by identifying unit 103.

Notifying unit 105 notifies a user that an event is identified by identifying unit 102. Display unit 106 displays an image. In this example, the event identified by identifying unit 102 is an event occurring in a virtual space, and is an event to change a visual aspect of a displayed character (which is an example of a virtual object). The process executed by processing unit 104 includes a process to change a display of the character.

Communication unit 107 communicates with another portable terminal 10. In this example, the process executed by processing unit 104 includes a process to transmit a parameter used for changing a display of a character to another portable terminal 10, via communication unit 107.

Image-obtaining unit 108 obtains an image. In this example, the event identified by identifying unit 102 is an event in which an image generated by combining the image obtained by image-obtaining unit 108 and the image of the character is displayed on display unit 106.

Display control unit 109 controls display unit 106 to display an image including a list of other portable terminal(s) 10 identified by identifying unit 103. Receiving unit 110 receives an instruction to select at least one portable terminal 10 from those on the list. Communication control unit 111 controls communication unit 107 to establish a communication connection with other portable terminal(s) selected as a result of the instruction received by the receiving unit 110. Executing unit 112 executes an application program.

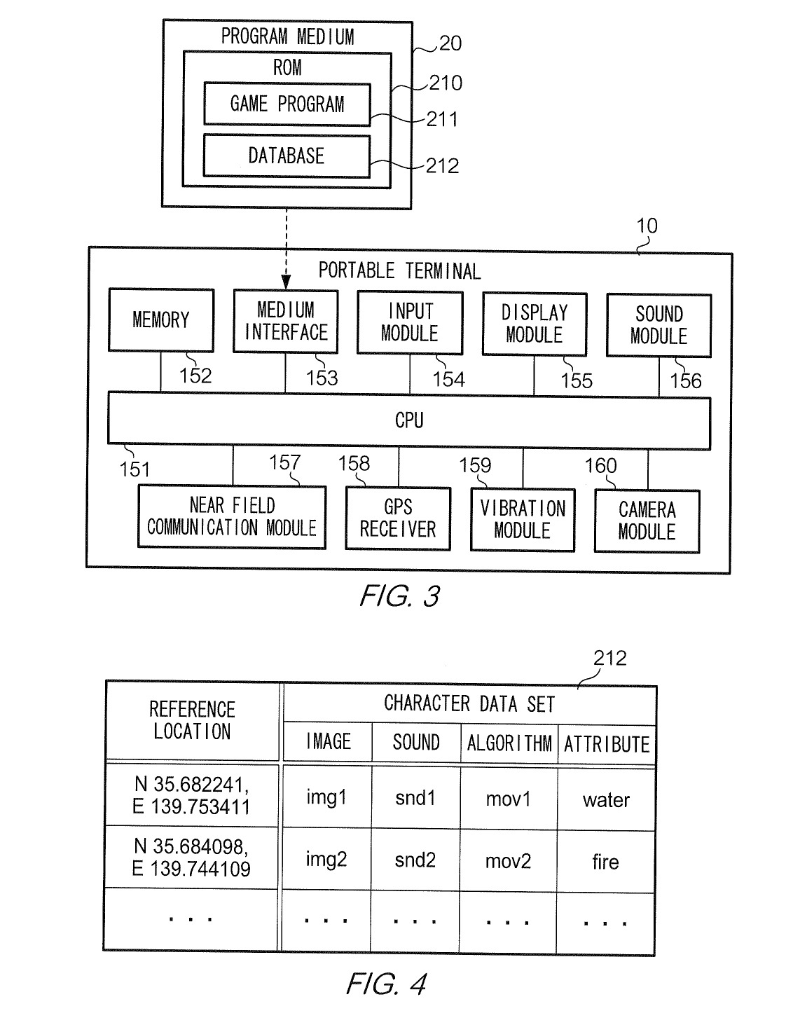

FIG. 3 shows an exemplary hardware configuration of portable terminal 10. Portable terminal 10 is a computer device including CPU (Central Processing Unit) 151, memory 152, medium interface 153, input module 154, display module 155, sound module 156, near field communication module 157, GPS (Global Positioning System) receiver 158, vibration module 159, and camera module 160. Program medium 20 includes ROM 210. In this example, portable terminal 10 is a portable game device. Further, ROM 210 in program medium 20 stores game program 211 and database 212. Game program 211 is a program causing the computer device to execute a process relating to a game. Database 212 is a database that records data (for example, data relating to an event corresponding to a location) used in the game.

CPU 151 is a device to control hardware modules of portable terminal 10, and execute an operation. Memory 152 is a storage device that stores a program and data, for example, RAM (Random Access Memory), ROM (Read Only Memory), or a combination thereof. Medium interface 153 is an interface to read or write data from or into program medium 20. In this example, program medium 20 is a so-called ROM cartridge, which includes a semiconductor memory that stores a program and data. Medium interface 153 has a slot into which the ROM cartridge is inserted.

Input module 154 includes an input device by which an instruction or a command from a user is input into CPU 151. Input module 154 includes, for example, a keypad, a button, a touch screen, a microphone, or any combination thereof. Display module 155 includes a device to display information including at least one of an image and a character. Display module 155 includes, for example, a display device (a liquid crystal display, or an organic electroluminescence display, for example), a driver circuit, and an image-processing circuit. Sound module 156 includes a device to output a sound. Sound module 156 includes, for example, an amplifier and a speaker.

Near field communication module 157 includes a device for performing wireless communication in accordance with a predetermined technical standard. Near field communication module 157 includes, for example, an antenna and a signal-processing circuit. Near field communication module 157 provides near field communication (so-called ad-hoc communication) between two or more portable terminals 10.

GPS receiver 158 includes a device for receiving a GPS signal from GPS satellites and calculating a location (for example, latitude and longitude) of the GPS receiver 158 by using the received signal. Vibration module 159 includes a device for generating a vibration so as to notify a user of an event. Vibration module 159 includes, for example, a motor and a driver circuit.

Camera module 160 is a device for obtaining (or shooting) an image (including a still image and/or a motion picture). Camera module 160 includes, for example, a camera (a lens and an image-sensing device) and an image-processing device. In this example, the camera of camera module 160 is mounted on a body (or chassis) (not shown in the figures) of portable terminal 10; more specifically, on a back panel of a display.

GPS receiver 158 is an example of positioning unit 101. CPU 151 executing a program is an example of identifying unit 102, identifying unit 103, processing unit 104, display control unit 109, and communication control unit 111. Vibration module 159 is an example of notifying unit 105. Display module 155 is an example of display unit 106. Near field communication module 157 is an example of communication unit 107. Camera module 160 is an example of image obtaining unit 108. Input module 154 is an example of receiving unit 110. CPU 151 is an example of executing unit 112. It is to be noted that the hardware configuration illustrated in FIG. 3 is merely an example and the hardware configuration is not limited thereto.

In this example, portable terminal 10 may be operated in a sleep mode. In the sleep mode, power consumption is decreased compared with a normal mode (awake mode). For example, an image is not displayed on display module 155 (which means power is not provided to display module 155). Transition from the normal mode to the sleep mode is triggered by a predetermined event, for example, closing a clamshell design body, or pushing a button to instruct that the transition be performed. It is to be noted that CPU 151 continues to operate in the sleep mode and executes at least a part of a program.

### 2. Operation

A description will now be given of an operation of information-processing system 1. In this example, the process described below is implemented by CPU 151, which is executing game program 211 stored in program medium 20. Game program 211 is a program causing a computer device to execute a process relating to a video game using location information obtained by GPS receiver 158. More specifically, the video game includes events corresponding to the current location of portable terminal 10 (which is indicated by the obtained location information). The events include, for example, an event to display a character (for example, a monster) in a specific geographic area, if the location information indicates that portable terminal 10 is at the specific geographic area. If plural portable terminals 10 are at the specific geographic area, plural portable terminals 10 execute a process relating to the character (for example, to beat the monster) simultaneously.

FIG. 4 shows an example of database 212. Database 212 includes plural set of records. Each record includes a reference location and a character data set. The character data set includes data indicating an image, a sound, a motion, and an attribute of the character. In this example, database 212 includes records of filenames of image data, sound data, and algorithm data. The algorithm data shows an algorithm of a motion of the character. Database 212 further includes records of character strings showing an attribute. For example, the top row in FIG. 4 indicates that image data, sound data, and algorithm data of a character that corresponds to a reference location of 35.682241 degrees north latitude and 139.753411 east longitude, are described in a file identified by filenames “img1,” “snd1,” and “mov1.” Further, the top row in FIG. 4 indicates that the character has an attribute of “water.”

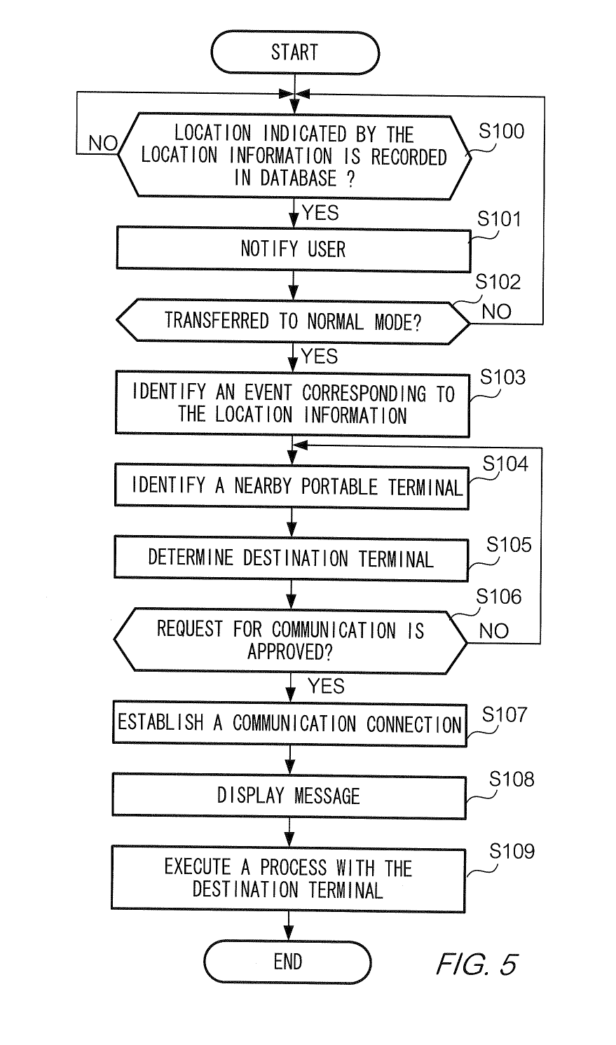

FIG. 5 shows an exemplary flow chart illustrating an operation of portable terminal 10. Prior to a process shown in FIG. 5, a user starts game program 211 on portable terminal 10. Then, the user instructs transition of the operation mode of portable terminal 10 into the sleep mode. Subsequently, the user moves around with portable terminal 10 being in the sleep mode.

In step S100, CPU 151 determines whether a location indicated by the location information obtained from the GPS receiver 158 is recorded in database 212. More specifically, CPU 151 determines whether the location information indicates a location within a predetermined area corresponding to a reference location (for example, an area of a circle with a radius of 10 meters, whose center is the reference location). If it is determined that the location is not recorded in database 212 (S100: NO), CPU 151 waits until it is determined that the location is recorded in database 212, with executing another process (which means CPU 151 does not pause when waiting). If it is determined that the location is recorded in database 212 (S100: YES), CPU 151 transfers the operation to step S101. It is to be noted that CPU 151 periodically obtains location information from GPS receiver 158. In such a case, GPS receiver 158 functions as positioning unit 101 in FIG. 2.

In step S101, CPU 151 notifies a user that portable terminal 10 enters an area relating to a reference location recorded in database 212. More specifically, CPU 151 controls vibration module 159 to generate a vibration for a predetermined time period. The vibration notifies the user that s/he has entered an area relating to a reference location recorded in database 212. In such a case, vibration module 159 functions as notifying unit 105 in FIG. 2.

In step S102, CPU 151 determines whether the operation mode is transferred from the sleep mode to the normal mode (in other words, CPU 151 determines whether portable terminal 10 has awakened from the sleep mode). If it is determined that the operation mode is transferred from the sleep mode to the normal mode (S102: YES), CPU 151 transfers the operation to step S103. If it is not determined that the operation mode is transferred from the sleep mode to the normal mode (S102: NO), CPU 151 transfers the operation to step S100. It is to be noted that the transfer from the sleep mode to the normal mode is triggered by an operation performed by a user (for example, opening a clamshell design body, pushing a power button, or touching a touch screen of portable terminal 10).

In step S103, CPU 151 identifies an event corresponding to the location information. In such a case, CPU 151 functions as identifying unit 102 in FIG. 2. In this case, the event corresponding to the location information is an event to display a character corresponding to the location information. More specifically, CPU 151 reads character data corresponding to the location information, from database 212. CPU 151 controls display module 155 to display an image in accordance with the character data. In this example, the image of the character is shown by using AR (Augmented Reality) technology. Details are as follows.

After transferring the operation mode from the sleep mode to the normal mode, CPU 151 controls camera module 160 to obtain an image. In such a case, camera module 160 functions as image-obtaining unit 108 in FIG. 2. In this case, since the camera of camera module 160 is mounted on the back panel of the display on the body, a direction of the line of sight of the user is approximately the same as a direction of the axis of the camera. In other words, an image shot by camera module 160 shows scenery similar to that the user can see. CPU 151 combines the image of scenery and the image of the character so that the image of the character overlaps the image of the scenery. CPU 151 controls the display module to display the combined image.

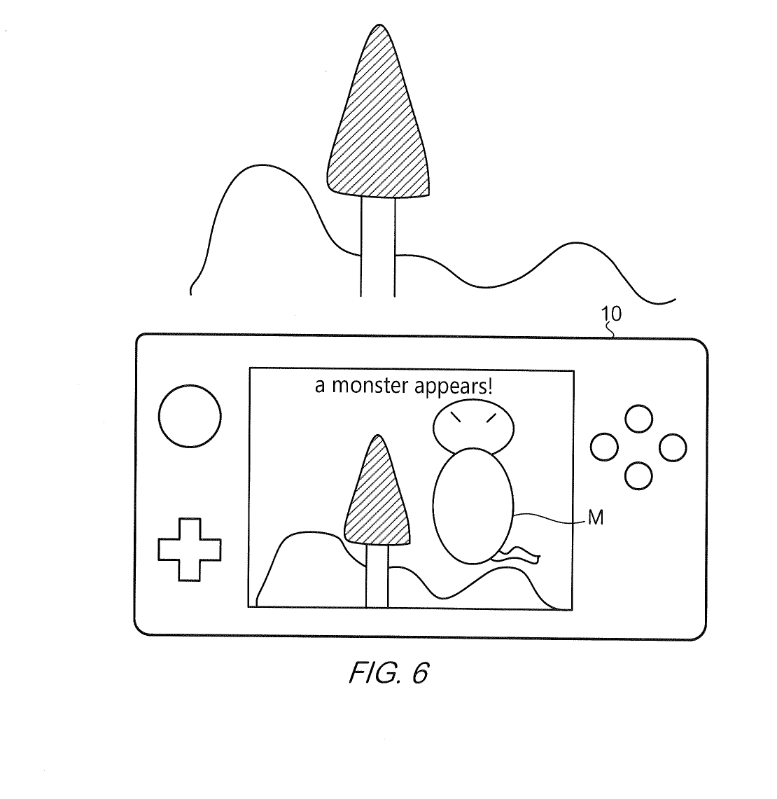

FIG. 6 shows an example of the combined image displayed in step S103. Image M of a character (a monster, in this example) is overlapped onto an image of scenery. The user thus has a virtual experience that a monster appears at the user's location.

Referring to FIG. 5 again, in step S104, CPU 151 (of portable terminal 10A) identifies (or detects) a nearby portable terminal 10 (portable terminal 10B). In such a case, CPU 151 functions as identifying unit 103 in FIG. 2. More specifically, CPU 151 controls near field communication module 157 to output a beacon signal (or a radio beacon). The beacon signal is a signal to establish a near field communication with another portable terminal 10. The beacon signal shows identification information (for example, MAC (Media Access Control) address) of the portable terminal 10 and an attribute (for example, a username and a level in the game). The other portable terminal 10 also outputs the beacon signal. Portable terminal 10A identifies portable terminal 10B by the beacon signal. Thus, in this example, the range of access of the beacon signal (of portable terminal 10A) is an example of an area including a location of portable terminal 10 (portable terminal 10A, for example).

In step S105, CPU 151 determines that communication with another portable terminal 10 is to be performed. In this example, the other portable terminal 10, which is a destination terminal of the communication, is selected by the user. CPU 151 controls display module 155 to display an image for prompting a user to select at least one portable terminal 10 as a candidate destination terminal (hereinafter, the image is referred to as “select menu”).

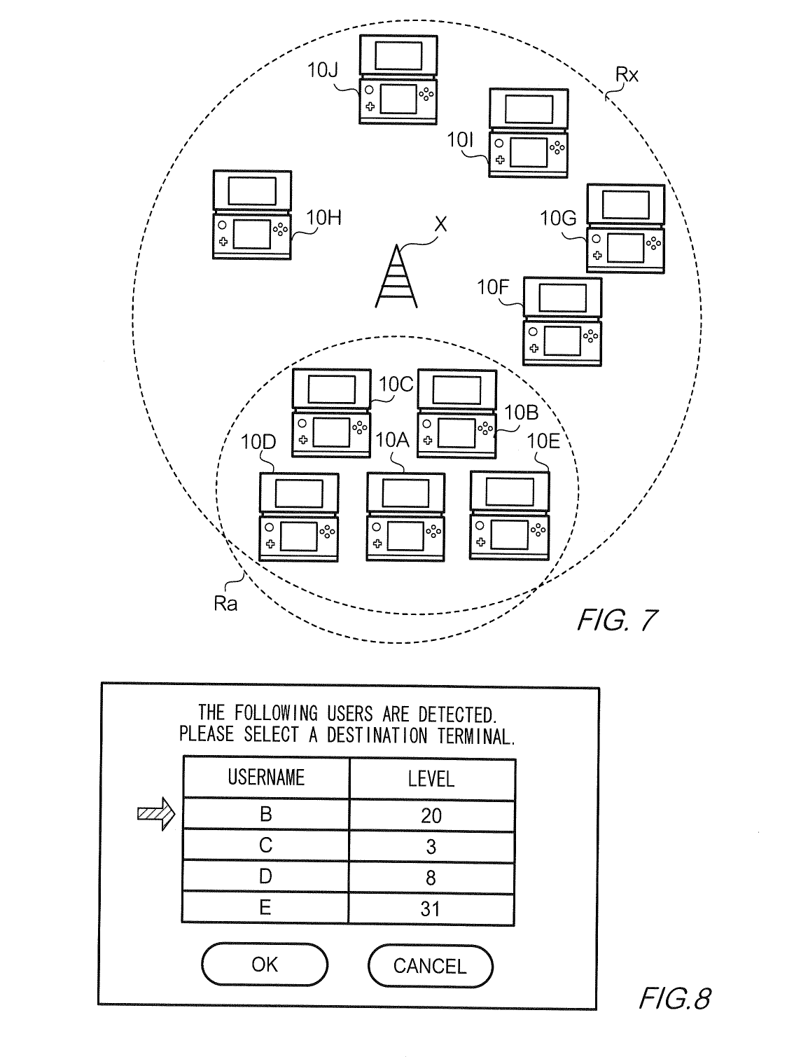

FIG. 7 shows an example of locations of portable terminals 10 relative to a reference location. In this example, in range Rx, which is defined by a circle with a radius of 10 meters, whose reference location X is the center, there are ten portable terminals 10, portable terminals 10A to 10J. For example, with regard to portable terminal 10A, which has a range of access Ra, there are four portable terminals 10, portable terminal 10B, 10C, 10D, and 10E, in the range of access Ra. It is to be noted that although Rx>Ra in this example, the relationship between the range relating to an event corresponding to a reference location and the range of access is not restricted to the range shown in the example.

FIG. 8 shows an example of a select menu displayed in step S105 in FIG. 8. On the display of portable terminal 10A, information including usernames and attributes of portable terminal 10B, 10C, 10D, and 10E are displayed. A user of portable terminal 10A inputs an instruction to select a destination terminal of the communication, via input module 154. In such a case, CPU 151 and input module 154 function as display control unit 109 and receiving unit 110, respectively. CPU 151 transmits a request for communication to another portable terminal 10 (for example, portable terminal 10B), which is selected by the user as the destination terminal. In such a case, CPU 151 functions as communication control unit 111 in FIG. 2. Receiving the request for communication, CPU 151 of portable terminal 10B controls display module 155 to display an image for prompting a user to confirm whether the user wishes to communicate with portable terminal 10A (hereinafter, the image is referred to as “confirmation menu”).

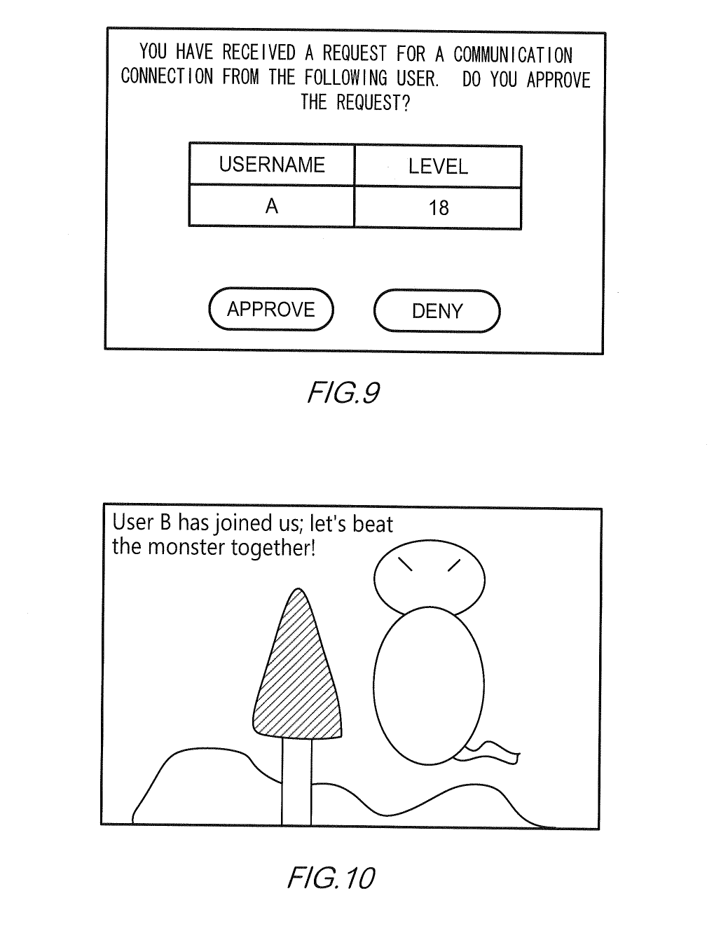

FIG. 9 shows an example of a confirmation menu. The confirmation menu is displayed on display module 155 of portable terminal 10B. In this example, the confirmation menu includes information showing a username and attribute (a level in a game, for example) of the user (user A) of portable terminal 10A, which is a source of the request for communication, as well as a message to confirm with the user (user B) of portable terminal 10B whether the user B wishes to communicate with the user A. User B inputs an instruction to communicate or not to communicate with user A, via input module 154. CPU 151 of portable terminal 10B transmits a response showing the request is approved or denied, to portable terminal 10A via near field communication module 157.

Referring to FIG. 5 again, in step S106, CPU 151 of portable terminal 10A determines whether the request for communication is approved. Whether the request for communication is approved is determined by using information included in the response from portable terminal 10B. If it is determined that the request for communication is approved (S106: YES), CPU 151 transfers the operation to step S107. If it is determined that the request for communication is denied (S106: NO), CPU 151 transfers the operation to step S104.

In step S107, CPU 151 of portable terminal 10A controls near field communication module 157 to establish a communication connection with portable terminal 10B. In such a case, near field communication module 157 functions as communication unit 107 in FIG. 2.

In step S108, CPU 151 of portable terminal 10A controls display module 155 to display a message showing that the communication connection with portable terminal 10B is established.

FIG. 10 shows an example of the message displayed in step S108. In this example, a message “User B has joined us; let's beat the monster together!” is displayed.

Referring to FIG. 5 again, in step S109, CPU 151 of portable terminal 10A executes a process relating to the event together with the destination terminal of the communication. In such a case, CPU 151 functions as processing unit 104 in FIG. 2. For example, CPU 151 controls the near field communication module 157 to transmit or receive a parameter relating to the event, and execute a process using the parameter. More specifically, the event is appearance of a monster. Portable terminals 10A and 10B transmit to and receive from each other parameters relating to attacking the monster (for example, a decrease in ‘hit points’ of the monster, or an amount of damage the monster receives), and execute a process for decreasing ‘hit points’ of the monster. Details are as follows.

CPU 151 of portable terminal 10A receives input from the user. The user inputs an instruction to attack the monster displayed on display module 155, via input module 154. CPU 151 calculates a parameter ΔP1 (<0), which shows a decrease in ‘hit points’ (hereinafter hit points P) of the monster, in response to the input by the user (user A). The parameter ΔP1 is calculated by using other parameters, for example, an attribute of the user. CPU 151 subtracts |ΔP1| from the hit points P (or calculates P+ΔP1). After the hit points P are decreased, CPU 151 changes a display of the monster, in response to the decreased hit points P. Also, CPU 151 of portable terminal 10B calculates a parameter ΔP2 (<0), which shows a decrease in hit points P of the monster, in response to the input by the user (user B). CPU 151 of portable terminal 10B subtracts |ΔP2| from P (or calculates P+ΔP2).

CPU 151 of portable terminal 10A transmits the parameter ΔP1 to portable terminal 10B. CPU 151 of portable terminal 10B transmits the parameter ΔP2 to portable terminal 10A. After receiving the parameter ΔP2 from portable terminal 10B, CPU 151 of portable terminal 10A subtracts ΔP2 from the hit points P. Similarly, receiving the parameter ΔP1 from portable terminal 10A, CPU 151 of portable terminal 10B subtracts ΔP1 from the hit points P. After the hit points P are decreased, CPU 151 changes a display of the monster, in response to the decreased hit points P. Thus, damage caused to the monster by the user (user B) of the destination terminal, as well as damage caused by the user (user A) of the portable terminal 10A, can be perceived by user A and user B. The user thus experiences attacking the monster in cooperation with the user of the destination terminal of the communication.

If a predetermined condition (for example, the hit points of the monster are less than zero) is satisfied, CPU 151 executes a process corresponding to the condition, for example, providing experience points or an item.

It is to be noted that FIG. 5 shows an example in which portable terminal 10 transmits a request for communication to another portable terminal 10. However, portable terminal 10 may receive a request for communication from another portable terminal 10. In such a case, an interruption occurs at a predetermined timing (in step S104 or S105, for example), and a process for prompting a user to approve the request is executed.

### 3. Modification

The present invention is not restricted to the embodiment described above. Various modifications can be applied to the exemplary embodiment. Some modifications will be described below. Two or more modifications from among the following modifications may be combined.

### 3-1. First Modification

A timing when notifying unit 105 notifies a user, is not restricted to an example described in the exemplary embodiment. Notifying unit 105 may notify a user when identifying unit 103 identifies another portable terminal 10, instead of (or in addition to) a timing when identifying unit 102 identifies an event.

### 3-2. Second Modification

In a case that notifying unit 105 (of portable terminal 10A) notifies a user when identifying unit 103 identifies another portable terminal 10 (portable terminal 10B), notifying unit 105 notifies the user only when an attribute of another portable terminal 10 satisfies a predetermined condition. For example, identification information of an application program executed in portable terminal 10B may be used as the attribute of portable terminal 10B. Further, the condition may be that portable terminal 10B is executing an application program identical to an application program executed in portable terminal 10A. In this example, the beacon signal output from portable terminal 10B shows identification information of an application program currently being executed in portable terminal 10B. Alternatively, the beacon signal may show identification information of application programs stored in portable terminal 10B. “Application programs stored in portable terminal 10B” includes an application program currently being executed in portable terminal 10B and/or application programs not currently being executed but stored in portable terminal 10B. In this case, notifying unit 105 (of portable terminal 10A) may notify the user when another portable terminal 10, which is executing an application program identical to the application program stored in portable terminal 10A, is identified, or when another portable terminal 10, which stores an application program identical to the application program stored in portable terminal 10A, is identified. In this example, the beacon signal output from portable terminal 10 shows identification information of application programs stored in the same portable terminal 10.

### 3-3. Third Modification

A method for determining a destination terminal of a communication connection is not restricted to an example in which a user selects the destination. Portable terminal 10 may determine the destination automatically. In such a case, portable terminal 10 includes a determining unit configured to determine the destination terminal. The determining unit determines the destination terminal in response to an attribute of portable terminal 10 (or a user thereof), for example. The attribute may be an attribute of portable terminal 10 or of a user thereof, such as a model of portable terminal 10, a sex of the user, an age of the user, or a hometown of the user. Further, The attribute may be an attribute relating to an executed application program such as a level of a character in a game, or hit points of the character. More specifically, the determining unit (of portable terminal 10A) selects as the destination at least one portable terminal 10 that has an attribute in common with that of portable terminal 10A, from among identified plural portable terminals 10. Alternatively, the determining unit (of portable terminal 10A) selects as the destination at least one portable terminal 10 that has an attribute different from that of portable terminal 10A.

### 3-4. Fourth Modification

The number of destination terminals of the communication connection is not restricted to one. Portable terminal 10 may communicate with two portable terminals 10 simultaneously. In other words, portable terminal 10 may execute a process relating to an event together with at least two other portable terminals 10. In this case, when two portable terminals 10 are connected by near field communication, the third portable terminal 10 may join the group so as to execute the process relating to the event together with the two portable terminals 10. In this example, at least one of the two portable terminals 10 (the first and the second portable terminals 10) transmits a beacon signal to establish a new communication connection while executing the process relating to the event. The third portable terminal 10 establishes a communication connection with the first and the second portable terminals 10 by using the beacon signal. Further, in such a case, grouping may be executed automatically. In a case that the grouping is executed automatically, notifying unit 105 may notify a user when the grouping is completed, instead of (or in addition to) a timing when identifying unit 102 identifies an event.

### 3-5. Fifth Modification

A method for communicating with another portable terminal 10 is not restricted to a method using near field communication module 157. For example, portable terminal 10 may communicate with another portable terminal 10 via a mobile communication network. In this example, portable terminal 10 includes a hardware module (mobile communication module, for example) to communicate via the mobile communication network.

### 3-6. Sixth Modification

An area to identify another portable terminal 10 as a destination terminal by portable terminal 10 (portable terminal 10A, for example), is not restricted to an area including the location of portable terminal 10A. An area to identify another portable terminal 10 as a destination terminal by portable terminal 10A may be an area including a location relating to an event. For example, in a case that portable terminal 10 communicates via a mobile communication network as in the fifth modification, a server device on a network may monitor locations of portable terminals 10 (for example, locations of base stations with which the portable terminals 10 communicate). If two portable terminals 10 are within an area relating to an event and the two portable terminals 10 are within a range of access of the near field communication, the server may notify the two portable terminals 10 that there is another portable terminal 10 within the range of access. Alternatively, if two portable terminals 10 are within an area relating to an event and the two portable terminals 10 are within a range of access of the near field communication, identifying unit 103 may identify another portable terminal 10. Further alternatively, if portable terminal 10A is outside an area relating to an event and portable terminal 10B is within the area, the server device may notify portable terminal 10A that portable terminal 10B has entered the area.

### 3-7. Other Modification

A flowchart shown in FIG. 5 is merely an example, and a process executed by portable terminal 10 is not restricted to the example. For example, portable terminal 10 may not transfer to the sleep mode.

In the exemplary embodiment, there is no server or client in portable terminals 10 communicating via the near field communication, and none of the communicating portable terminals 10 has a priority. However, one of the communicating portable terminals 10 may function as a server and the other portable terminals 10 may function as clients. In such a case, the server may execute a calculation (for example, calculation of damage to a monster) for a process relating to an event, and transmit the results to clients.

A method for obtaining the location information is not restricted to a method using positioning unit 101. CPU 151 may obtain location information by a method using a technology other than GPS. For example, CPU 151 may obtain location information from an access point of wireless LAN (Local Area Network). In such a case, portable terminal 10 includes a hardware module to communicate via the wireless LAN. Alternatively, portable terminal 10 may obtain location information from a base station of a mobile communication network. In such a case, portable terminal 10 includes a hardware module to communicate via the mobile communication network.

Notifying unit 105 is not restricted to vibration module 159. Notifying unit 105 may notify a user by stimulating a sense other than a sense of touch; for example, stimulating by sound, light, smell, or any combination thereof.

At least a part of functional configuration shown in FIG. 2 may be omitted. For example, portable terminal 10 may not include image obtaining unit 108. In such a case, an event relating to a location may not include an event to combine an image of a character and an obtained image.

Portable terminal 10 is not restricted to a game device. Portable terminal 10 may be an information-processing device other than a game device; for example, a personal computer, a mobile phone, a PDA (Personal Digital Assistant), or a tablet device.

A process executed by the game program is not restricted to an example described in the exemplary embodiment. A process relating to the location information may be a process other than displaying a character corresponding to the location information, for example, sharing or fighting over an item corresponding to the location information with plural portable terminals 10. Further, an application program executed in portable terminal 10 is not restricted to a game program. The application program may be a program other than a game program; for example, an application program for editing a document, an educational application program, or a business application program, as long as the program causes plural portable terminals 10 to carry out a common process.

Program medium 20 is not restricted to a ROM cartridge. Program medium 20 may be a computer readable non-transitory storage device other than a semiconductor memory; for example, a magnetic medium such as magnetic tape or a magnetic disk (for example, a hard disk, a flexible disk, etc), an optical medium such as an optical disk such as CD (Compact Disc) or DVD (Digital Versatile Disc)), or a magnetic optical medium.

An application program executed in portable terminal 10 is not restricted to a program stored in program medium 20. The program may be downloaded via a network; for example, the Internet. Further, even if the application program is stored in program medium 20, data relating to an event corresponding to the location information may be downloaded via a network.

1. An information-processing device comprising:
a first identifying unit configured to identify an event occurring at a location of the information-processing device, wherein the event is associated with a virtual object and an algorithm;
a communication unit configured to communicate with another information-processing device which is within an area including the location of the information-processing device or a location where the event occurs; and
a processing unit configured to execute a process relating to the event identified by the first identifying unit, together with the another information-processing device communicating via the communication unit, wherein the process includes operating the virtual object in accordance with the algorithm.

2. The information-processing device according to claim 1, further comprising
a notifying unit configured to notify a user that the event is identified by the first identifying unit.

3. The information-processing device according to claim 1, further comprising an executing unit configured to execute an application program, wherein
the communication unit is further configured to communicate with another information-processing device that is executing an application program identical to the application program executed by the executing unit.

4. The information-processing device according to claim 1, wherein
the first identifying unit is further configured to identify the event that corresponds to the information-processing device and that occurs in a virtual space.

5. The information-processing device according to claim 1, wherein
the first identifying unit is further configured to identify a virtual object corresponding to the location of the information-processing device, and
the information-processing device further comprises
a first display control unit configured to control a display unit to display the virtual object identified by the first identifying unit.

6. The information-processing device according to claim 5, wherein
the processing unit is further configured to execute the process relating to the virtual object displayed on the display unit, together with the other information-processing device.

7. The information-processing device according to claim 5, wherein the process includes a process to change a display of the virtual object.

8. The information-processing device according to claim 7, wherein
the process includes a process to transmit a parameter used to change the display of the virtual object, to the other information-processing device via the communication unit.

9. The information-processing device according to claim 5, further comprising an image obtaining unit configured to obtain an image, wherein
the first display control unit is configured to control the display unit to display an image generated by combining the image obtained by the image obtaining unit and an image of the virtual object.

10. The information-processing device according to claim 1, further comprising:
a second identifying unit configured to identify another information-processing device that is located within the area;
second display control unit configured to control the display unit to display an image including a list of the other information-processing device(s) identified by the second identifying unit;
a receiving unit configured to receive an instruction to select at least one information-processing device from among the information-processing device(s) included in the list, wherein
the communication unit is further configured to communicate with the information-processing device(s) selected in accordance with the instruction received by the receiving unit.

11. A method comprising:
identifying an event corresponding to a location of an information-processing device, wherein the event is associated with a virtual object and an algorithm;
communicating with another information-processing device which is within an area including the location of the information-processing device or a location of the event; and
executing a process relating to the identified event together with the other information-processing device with which communication is being made, wherein the process includes operating the virtual object in accordance with the algorithm.

12. A information-processing system comprising:
a first portable terminal; and
a second portable terminal, wherein
each of the first portable terminal and the second portable terminal includes:
an identifying unit configured to identify an event occurring at a location of the information-processing device, wherein the event is associated with a virtual object and an algorithm;
a communication unit configured to communicate with another information-processing device which is within an area including the location of the information-processing device or a location where the event occurs; and
a processing unit configured to execute a process relating to the event identified by the identifying unit, together with the other information-processing device communicating via the communication unit, wherein the process includes operating the virtual object in accordance with the algorithm.

13. A computer-readable non-transitory storage medium storing a program which, when executed by a computer device, causes the computer device to perform operations comprising:
identifying an event occurring at a location of the computer device, wherein the event is associated with a virtual object and an algorithm;
communicating with another computer device which is within an area including the location of the computer device or a location where the event occurs; and
executing a process relating to the identified event together with the other computer device with which communication is being made, wherein the process includes operating the virtual object in accordance with the algorithm.

14. The information-processing device according to claim 1, wherein the first identifying unit is further configured to identify the event occurring at a geographic location of the information-processing device based upon an association between the event and the geographic location; and
wherein the processing unit is further configured to execute the process relating to the event by exchanging parameters related to the event with the another information-processing device when the information-processing device and the another information processing device are in proximity to the geographic location.

15. The information-processing device according to claim 1, wherein
the association between a plurality of events and geographic locations are defined by a program, and
the first identifying unit is further configured to identify the event from among the plurality of events defined by the program.

16. The computer-readable non-transitory storage medium according to claim 13, wherein the association between a plurality of events and geographic locations are defined by a program, and wherein the operations further comprise identifying the event from among the plurality of events defined by the program.

17. The information-processing system according to claim 12, wherein the association between a plurality of events and geographic locations are defined by a program, and wherein the identifying unit is further configured to identify the event from among the plurality of events defined by the program.

18. The method according to claim 11, wherein the association between a plurality of events and geographic locations are defined by a program, and wherein the method further comprise identifying the event from among the plurality of events defined by the program.
